(19) United States
(12) Patent Application Publication
(10) Pub. No.: US 2012/0015249 A1
(43) Pub. Date: Jan. 19, 2012

(54) LITHIUM PHOSPHORUS COMPLEX OXIDE-CARBON COMPOSITE, METHOD FOR PRODUCING SAME, POSITIVE ELECTRODE ACTIVE MATERIAL FOR LITHIUM SECONDARY BATTERY, AND LITHIUM SECONDARY BATTERY

(75) Inventors: Hidekazu Awano, Tokyo (JP); Kazuya Taga, Tokyo (JP)

(73) Assignee: NIPPON CHEMICAL INDUSTRIAL CO., LTD., Tokyo (JP)

(21) Appl. No.: 13/255,204

(22) PCT Filed: Mar. 17, 2010
(86) PCT No.: PCT/JP2010/054486

§ 371 Date: Sep. 23, 2011

(30) Foreign Application Priority Data
Mar. 17, 2009 (JP) 2009-064284

(51) Int. Cl. H01M 4/131; B02C 23/00; H01B 1/04

(52) U.S. Cl. 429/221; 429/223; 429/224; 252/506; 241/3

(57) ABSTRACT

A lithium phosphorus complex oxide-carbon composite which has high electrode density and is capable of improving the rate characteristics of a lithium secondary battery. Specifically disclosed is a lithium phosphorus complex oxide-carbon composite which is characterized by being an aggregate of lithium phosphorus complex oxide particles represented by general formula (1), the lithium phosphorus complex oxide particles aggregating via a conductive carbon material. The lithium phosphorus complex oxide-carbon composite is also characterized in that the aggregate has an average particle diameter of 1-30 μm and a tap density of not less than 0.8 g/cm³. General formula (1): LiMPO₄ (In the formula, M represents one or more metal elements selected from the group consisting of Fe, Mn, Co, Ni and V.)

### BACKGROUND OF THE INVENTION

1. Field of the Invention

The present invention relates to a lithium phosphorus complex oxide-carbon composite, a method for producing the same, and a lithium secondary battery using the same.

2. Description of the Related Art

In recent years, with advances in portability and wirelessness of domestic electrical appliances, lithium ion secondary batteries have been put to practical use as a power supply for small-sized electronic instruments such as laptop personal computers, mobile telephones, and video cameras. In regard to these lithium ion secondary batteries, research and development on lithium ion secondary batteries using a lithium cobaltate composite oxide as a positive electrode active material is being actively conducted, and there have been hitherto made many suggestions thereon.

However, since Co is a rare resource that is unevenly present on the Earth, as a new positive electrode active material substituting lithium cobaltate, development of, for example, LiNiO₂, LiMn₂O₄, LiMPO₄ (wherein M represents at least one metal element selected from Fe, Mn, Co, Ni and V) and the like is in progress.

Particularly, LiFePO₄ has a volume density as large as 3.6 g/cm³, has a high potential of 3.4 V, and contains one Li that can be electrochemically dedoped per Fe atom. Therefore, LiFePO₄ is strongly expected to act as a new positive electrode active material for lithium secondary batteries substituting lithium cobaltate.

Since compounds having an olivine structure, including this LiFePO₄, have very low electron conductivity, an investigation is being conducted on the use of the compounds in combination with electrically conductive carbon materials, as a lithium complex oxide-carbon composite (see, for example, Patent Documents 1 to 3).
Patent Document 1: JP-A-2002-75364 (Claims)
Patent Document 2: JP-A-2003-292308 (Claims)
Patent Document 3: JP-A-2003-292309 (Claims)

### SUMMARY OF THE INVENTION

However, lithium phosphorus complex oxide-carbon composite produced by a traditional method is a mixture of LiMPO₄ and a bulky conductive carbon material, or a composite in which the surface of LiMPO₄ is simply coated with a bulky conductive carbon material. Therefore, the resulting mixture of a lithium phosphorus complex oxide and a conductive carbon material or the resulting lithium phosphorus complex oxide-carbon composite has a low electrode density. Furthermore, there is a demand for a further enhancement of the rate performance of these positive electrode active materials.

Therefore, it is desirable to provide a lithium phosphorus complex oxide-carbon composite which has a high electrode density and can enhance the rate performance of lithium secondary batteries.

The inventors of the invention conducted a thorough investigation in order to solve the problems of the related art, and as a result, the inventors found that (1) at the time of obtaining a lithium phosphorus complex oxide, when those raw materials are mixed together with an electrically conductive carbon material or a precursor thereof and calcined at a temperature as low as 500° C. to 900° C., a composite in which fine lithium phosphorus complex oxide particles are coated with a conductive carbon material is obtained; (2) when the composite thus obtained is aggregated while compressed, by mechanochemically treating the complex to apply mechanical energy to plural composites, and the average particle size of the resulting aggregate is adjusted to 1 to 30 μm, while the tap density is adjusted to 0.8 g/cm³ or more, an aggregate in which fine lithium phosphorus complex oxide particles are aggregated with a compact conductive carbon material binding the particles, can be obtained; and (3) the lithium phosphorus complex oxide-carbon composite which is such an aggregate, has a high electrode density and can increase the rate performance of lithium secondary batteries, thus completing the invention.

That is, according to a first aspect of the invention, there is provided a lithium phosphorus complex oxide-carbon composite in which an aggregate of lithium phosphorus complex oxide particles represented by the following formula (1):

LiMPO₄ (1)

(wherein M represents one or more metal elements selected from the group consisting of Fe, Mn, Co, Ni and V)

are aggregated with a conductive carbon material, wherein the average particle size of the aggregate is 1 to 30 μm, and the tap density of the aggregate is 0.8 g/cm³ or more.

According to a second aspect of the invention, there is provided a method for producing a lithium phosphorus complex oxide-carbon composite, the method including a raw material mixing step (a) of mixing a lithium source, a phosphorus source, one or more metal element (M metal element) sources selected from the group consisting of Fe, Mn, Co, Ni and V, and a conductive carbon material source to obtain a raw material mixture (a); a pressure molding step (a) of pressure molding the raw material mixture (a) to obtain a pressure molded product of the raw material mixture (a); a calcination step (a) of calcining the pressure molded product of the raw material mixture (a) in an inert gas atmosphere at 500° C. to 900° C., and thereby obtaining a composite (a) in which lithium phosphorus complex oxide particles represented by the following formula (1):

LiMPO₄ (1)

(wherein M represents one or more metal elements selected from the group consisting of Fe, Mn, Co, Ni and V) are coated with a conductive carbon material; and a granulation step (a) of mechanochemically treating the composite (a) until an average particle size of the aggregate of 1 to 30 μm and a tap density of 0.8 g/cm³ or more are obtained, and thereby obtaining an aggregate (a) in which the lithium phosphorus complex oxide particles represented by the formula (1) are aggregated, with the conductive carbon material binding the particles.

According to a third aspect of the invention, there is provided a method for producing a lithium phosphorus complex oxide-carbon composite, the method including a first raw material mixing step (b) of mixing a lithium source, a phosphorus source, one or more metal element (M metal element) sources selected from the group consisting of Fe, Mn, Co, Ni and V, and a precursor of a conductive carbon material to obtain a first raw material mixture (b1); a second raw material mixing step (b) of mixing a conductive carbon material with the first raw material mixture (b1) to obtain a second raw material mixture (b2); a pressure molding step (b) of pressure molding the second raw material mixture (b2) to obtain a pressure molded product of the second raw material mixture (b2); a calcination step (b) of calcining the pressure molded product of the second raw material mixture (b2) in an inert gas atmosphere at 500° C. to 900° C., and thereby obtaining a composite (b) in which lithium phosphorus complex oxide particles represented by the following formula (1):

LiMPO₄ (1)

(wherein M represents one or more metal elements selected from the group consisting of Fe, Mn, Co, Ni and V) are coated with a conductive carbon material; and a granulation step (b) of mechanochemically treating the composite (b) until an average particle size of the aggregate of 1 to 30 μm and a tap density of 0.8 g/cm³ or more are obtained, and thereby obtaining an aggregate (b) in which the lithium phosphorus complex oxide particles represented by the following formula (1) are aggregated, with the conductive carbon material binding the particles.

According to a fourth aspect of the invention, there is provided a method for producing a lithium phosphorus complex oxide-carbon composite, the method including a raw material mixing step (c) of mixing a lithium source, a phosphorus source, one or more metal element (M metal element) sources selected from the group consisting of Fe, Mn, Co, Ni and V, and a precursor of a conductive carbon material to obtain a raw material mixture (c); a pressure molding step (c) of pressure molding the raw material mixture (c) to obtain a pressure molded product of the raw material mixture (c); a calcination step (c) of calcining the pressure molded product of the raw material mixture (c) in an inert gas atmosphere at 500° C. to 900° C., and thereby obtaining a complex (c) in which lithium phosphorus complex oxide particles represented by the following formula (1):

LiMPO₄ (1)

(wherein M represents one or more metal elements selected from the group consisting of Fe, Mn, Co, Ni and V) are coated with a conductive carbon material; and a granulation step (c) of further mixing a conductive carbon material with the composite (c), subsequently mechanochemically treating the mixture of the composite (c) and the conductive carbon material until an average particle size of the aggregate of 1 to 30 μm and a tap density of 0.8 g/cm³ are obtained, and thereby obtaining an aggregate (c) in which the lithium phosphorus complex oxide particles represented by the formula (1) are aggregated, with the conductive carbon material binding the particles.

According to a fifth aspect of the invention, there is provided a positive electrode active material for lithium secondary batteries, containing the lithium phosphorus complex oxide of the first aspect of the invention.

According to a sixth aspect of the invention, there is provided a lithium secondary battery using the lithium phosphorus complex oxide-carbon composite of the first aspect of the invention as a positive electrode active material for lithium secondary batteries.

According to the above-described aspects of the invention, it is possible to provide a lithium phosphorus complex oxide-carbon composite which has a high electrode density and can enhance the rate performance of lithium secondary batteries.

### BRIEF DESCRIPTION OF THE DRAWINGS

FIG. 1 is a schematic cross-sectional diagram of a composite in which lithium phosphorus complex oxide particles are coated with a conductive carbon material;

FIG. 2 is a schematic cross-sectional diagram of an aggregate in which lithium phosphorus complex oxide particles are aggregated, with a conductive carbon material;

FIG. 3 is an electron microscopic photograph of the aggregate (A2) obtained in Example 1;

FIG. 4 is an X-ray diffraction chart of the aggregate (A2) obtained in Example 1; and

FIG. 5 is an electron microscopic photograph of the agitation-treated product (c2) obtained in Comparative Example 3.

### DESCRIPTION OF THE PREFERRED EMBODIMENTS

The lithium phosphorus complex oxide-carbon composite of the invention is a lithium phosphorus complex oxide-carbon composite which is an aggregate in which lithium phosphorus complex oxide particles represented by the following formula (1):

LiMPO₄ (1)

(wherein M represents one or more metal elements selected from the group consisting of Fe, Mn, Co, Ni and V) are aggregated, with a conductive carbon material, and the average particle size of the aggregate is 1 to 30 μm, while the tap density of the aggregate is 0.8 g/cm³ or more.

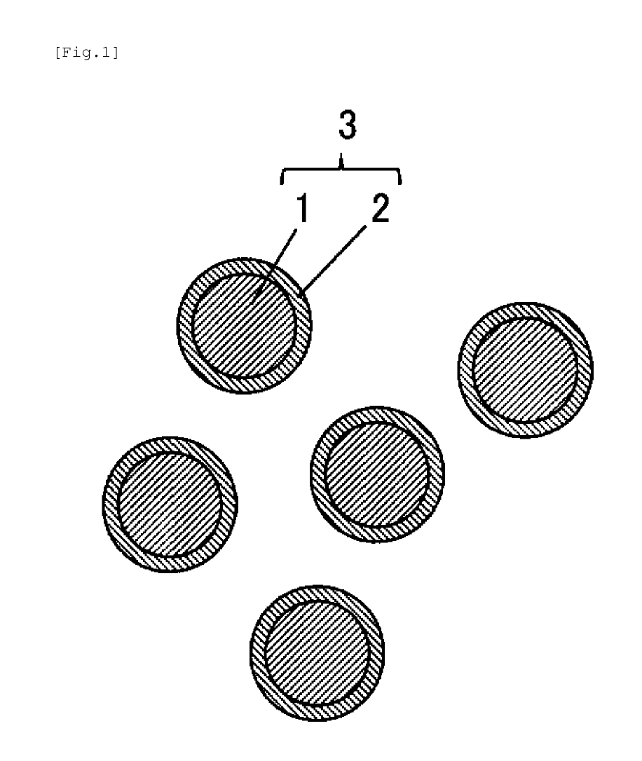

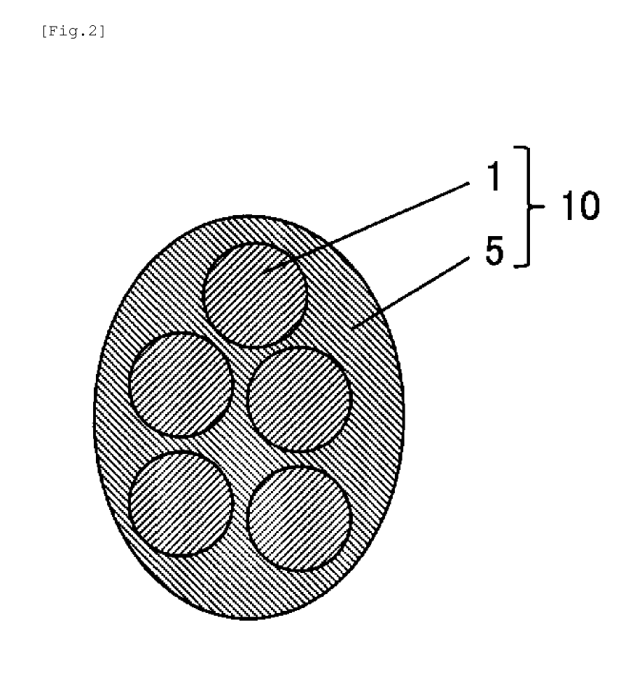

The structure of the lithium phosphorus complex oxide-carbon composite of the invention will be described with reference to FIG. 1 and FIG. 2.

The lithium phosphorus complex oxide-carbon composite of the invention is an aggregate (a) 10 which is obtained by first calcining a raw material mixture (a) obtainable by mixing a lithium source, a phosphorus source, an M metal element source and a conductive carbon material source, in an inert gas atmosphere at 500° C. to 900° C., to obtain a composite (a) 3 in which lithium phosphorus complex oxide particles 1 are coated with a conductive carbon material (a1) 2 as shown in FIG. 1, subsequently mechanochemically treating the composite (a) 3 thus obtained, and thereby aggregating plural composites (a) 3 while compressing the composites, that is, an aggregate (a) 10 in which plural lithium phosphorus complex oxide particles 1 are aggregated, with a compact conductive carbon material (a2) 5 binding the particles as shown in FIG. 2. FIG. 1 is a schematic cross-sectional diagram of the aggregate (a) 3 obtainable by calcining the raw material mixture (a), while FIG. 2 is a schematic cross-sectional diagram of the aggregate (a) 10 obtainable by mechanochemically treating the composite (a), that is, the lithium phosphorus complex oxide-carbon composite of the invention.

In FIG. 1, the lithium phosphorus complex oxide particles 1 of the composite (a) 3 are fine particles which are obtained by calcining the raw material mixture (a) at a low temperature such as 500° C. to 900° C. The composite (a) 3 is a lithium phosphorus complex oxide-carbon composite in which the surfaces of these fine lithium phosphorus complex oxide particles 1 are coated with a conductive carbon material (a1) 2. In the composite (a) 3, the conductive carbon material (a1) 2 is a collection of powdered conductive carbon material having a particle size smaller than the lithium phosphorus complex oxide particles 1, or a film in which the conductive carbon material is integrated. That is, the conductive carbon material (a1) 2 is a material in which a large number of conductive carbon material powder particles deposit in a layer on the surfaces of the lithium phosphorus complex oxide particles 1, or a film-like conductive carbon material coating the surfaces of the lithium phosphorus complex oxide particles 1.

In FIG. 2, the aggregate (a) 10 is an aggregate which is formed as mechanical energy such as compressive force and shear force are applied to the plural composite (a) 3 particles by mechanochemically treating the composite (a) 3, and thereby the plural composite (a) 3 particles are aggregated while compressed. At this time, since the conductive carbon material (a1) is strongly compressed by the mechanochemical treatment, the conductive carbon material (a1) turns into a compact conductive carbon material (a2) 5. That is, the aggregate (a) 10 is an aggregate in which plural fine lithium phosphorus complex oxide particles 1 are firmly aggregated, with the compression product of the conductive carbon material (a1) 2, that is, the compact conductive carbon material (a2) 5 binding the particles. Furthermore, in the aggregate (a) 10, the conductive carbon material is present not only on the surfaces, as in the case of the composite (a) 2, but also in the interior of the aggregate.

When the raw material mixture (a) is calcined to obtain a composite (a) 3, the raw material mixture (a) is pressure molded in order to increase the reactivity of the raw materials. Therefore, the conductive carbon material (a1) 2 is compressed with a force to the same extent as that used to apply pressure at the time of pressure molding. Accordingly, the density of the conductive carbon material (a1) 2 is higher than the density of the conductive carbon material source that serves as the raw material. However, this force that is applied at the time of pressure molding is smaller than the force that is applied by the mechanochemical treatment of the subsequent step. Therefore, the density of the conductive carbon material (a1) 2 coating the surfaces of the composite (a) 3 is smaller than the density of the conductive carbon material (a2) 5 in the aggregate (a) 10.

The lithium phosphorus complex oxide particles represented by the formula (1), which are related to the lithium phosphorus complex oxide-carbon composite of the invention, are fine lithium phosphorus complex oxide particles existing inside the aggregate.

In the formula (1), M represents one or more metal elements selected from the group consisting of Fe, Mn, Co, Ni and V. M may be used individually, or a combination of two or more kinds may also be used. Among these, Fe is preferable from the viewpoint that the operating voltage of a lithium secondary battery which uses a lithium phosphorus complex oxide-carbon composite as a positive electrode active material is close to the operating voltage of a lithium secondary battery which uses a lithium cobaltate complex oxide as a positive electrode active material, and an appropriate voltage can be maintained.

Specific examples of the conductive carbon material include graphite, such as natural graphite such as scale-like graphite, flake graphite and earth-like graphite, and artificial graphite; carbon blacks such as carbon black, acetylene black, ketjen black, channel black, furnace black, lamp black, and thermal black; and carbon fibers. Among these, ketjen black is preferable. The conductive carbon material may be used individually or in combination of two or more kinds.

The conductive carbon material related to the lithium phosphorus complex oxide carbon composite of the invention may be a material that is obtained by calcining a precursor of a conductive carbon material in an inert gas atmosphere at 500° C. to 900° C., and preferably at 550° C. to 700° C. The precursor of a conductive carbon material may be a precursor which is converted to a conductive carbon material related to the lithium phosphorus complex oxide-carbon composite of the invention, by being calcined in an inert gas atmosphere at 500° C. to 900° C., and preferably at 550° C. to 700° C. Examples of the precursor of a conductive carbon material include coal tar pitch, including soft pitch and hard pitch; coal-based heavy oil such as pyrolysis oil, rectified heavy oil such as normal pressure residue oil and reduced pressure residue oil, petroleum-based heavy oil of decomposition heavy oil such as ethylene tar, which is produced as a side-product at the time of thermal decomposition of crude oil, naphtha and the like; aromatic hydrocarbons such as acenaphthylene, decacyclene, anthracene, and phenanthrene; polyphenylenes such as phenazine, biphenyl, and terphenyl; polyvinyl chloride; water-soluble polymers such as polyvinyl alcohol, polyvinyl butyral, and polyethylene glycol, and insolubilization-treated products thereof; nitrogen-containing polyacrylonitrile; organic polymers such as polypyrrole; sulfur-containing organic polymers such as polythiophene and polystyrene; natural polymers such as saccharides such as starch, cellulose, lignin, mannan, polygalacturonic acid, chitin, chitosan, saccharose, and sucrose; thermoplastic resins such as polyphenylene sulfide and polyphenylene oxide, and thermosetting resins such as phenol-formaldehyde resins, and imide resins. Among these, saccharides are preferable. The precursor of a conductive carbon material may be used individually or in combination of two or more kinds. The precursors of the conductive carbon material are classified into a material which turns into many fine particles of the conductive carbon material when calcined in an inert gas atmosphere, and deposits in a layer on the surface of the lithium phosphorus complex oxide particles; and a material which forms a film-like conductive carbon material that coats the surfaces of the lithium phosphorus complex oxide particles.

The average particle size of the aggregate related to the lithium phosphorus complex oxide-carbon composite of the invention is an average particle size determined by a laser light scattering method, and is 1 to 30 μm, and preferably 1 to 20 μm. When the average particle size of the aggregate is less than the range described above, the rate performance of the lithium secondary batteries is deteriorated, and when the average particle size is greater than the range described above, the rate performance is deteriorated.

The tap density of the aggregate related to the lithium phosphorus complex oxide-carbon composite of the invention is 0.8 g/cm³ or more, preferably 0.8 to 2.0 g/cm³, and particularly preferably 0.9 to 2.0 g/cm³. Since the conductive carbon material in the lithium phosphorus complex oxide-carbon composite of the invention (conductive carbon material (a2) under Reference Numeral 5 in FIG. 2) is a compression product of the conductive carbon material (conductive carbon material (a1) under Reference Numeral 2 in FIG. 1), the conductive carbon material is a compact conductive carbon material. According to the invention, the tap density of the aggregate being in the range described above implies that the conductive carbon material is a compressed, compact conductive carbon material. On the other hand, a composite which has not been mechanochemically treated, for example, the composite (a) 3 in FIG. 1, is such that since the density of the conductive carbon material (a) 2 coating the composite is low, the tap density of the composite (a) 3 is smaller than the range described above. When the tap density of the aggregate is in the range described above, the electrode density of the positive electrode active material is increased, and the rate performance of lithium secondary batteries is improved.

In the lithium phosphorus complex oxide-carbon composite of the invention, the average particle size of the lithium phosphorus complex oxide particles represented by the formula (1) and present inside the aggregate (the average particle size of the lithium phosphorus complex oxide particles under Reference Numeral 1 in FIG. 2) is the average particle size determined by scanning electron microscopy (SEM), and is preferably 10 to 500 nm, and particularly preferably 10 to 300 nm. When the average particle size of the lithium phosphorus complex oxide particles represented by the formula (1) and present inside the aggregate is in the range described above, the rate performance of lithium secondary batteries is improved, and the charge-discharge capacity is increased. On the other hand, when the average particle size of the lithium phosphorus complex oxide particles present inside the aggregate is less than the range described above, the rate performance of lithium secondary batteries is likely to be deteriorated, and when the average particle size is greater than the range described above, the charge-discharge capacity of lithium secondary batteries is likely to be decreased. The average particle size of the lithium phosphorus complex oxide particles represented by the formula (1) and present inside the aggregate may be obtained as described below. First, the aggregate is observed by scanning electron microscopic photography (SEM), and based on an SEM photograph thus obtained, the particle size of each of the lithium phosphorus complex oxide particles present inside the aggregate is measured. Furthermore, for twenty aggregates arbitrarily selected, the particle size of each of the lithium phosphorus complex oxide particles present inside the same aggregates is measured. Subsequently, all the particles sizes thus measured are averaged, and thus the average particle size is calculated.

In the lithium phosphorus complex oxide-carbon composite of the invention, the content of the conductive carbon material inside the aggregate is preferably 0.5% to 10% by mass, and particularly preferably 1% to 10% by mass, in terms of carbon atoms. When the content of the conductive carbon material inside the aggregate is in the range described above, the battery capacity of lithium secondary batteries is increased, and the capacity reduction is also decreased. When the content of the conductive carbon material inside the aggregate is less than the range described above, the battery capacity of lithium secondary batteries is likely to be decreased, and when the content is greater than the range described above, the capacity reduction of lithium secondary batteries is likely to increase. According to the invention, the content of the conductive carbon material is determined by making a measurement using a TOC total organic carbon meter (TOC-5000A manufactured by Shimadzu Corp., or the like).

In the lithium phosphorus complex oxide-carbon composite of the invention, the electrode density of the aggregate is preferably 2.8 g/cm³ or more, and particularly preferably 2.9 to 3.3 g/cm³, from the viewpoint of increasing the capacity per electrode.

In the lithium phosphorus complex oxide-carbon composite of the invention, the BET specific surface area of the aggregate is preferably 10 m²/g or more, and particularly preferably 10 to 100 m²/g, from the viewpoint of increasing the electrode coatability.

The lithium phosphorus complex oxide-carbon composite of the invention is suitably produced by the method for producing a lithium phosphorus complex oxide-carbon composite of the invention as described below.

The method for producing a lithium phosphorus complex oxide-carbon composite of a first embodiment of the invention (hereinafter, also described as the method (1) for producing a lithium phosphorus complex oxide-carbon composite of the invention) is a method for producing a lithium phosphorus complex oxide-carbon composite, the method including a raw material mixing step (a) of obtaining a raw material mixture (a) containing a lithium source, a phosphorus source, one or more metal element (M metal element) sources selected from the group consisting of Fe, Mn, Co, Ni and V, and a conductive carbon material source; a pressure molding step of pressure molding the raw material mixture (a) to obtain a pressure molded product of the raw material mixture (a); a calcination step (a) of calcining the pressure molded product of the raw material mixture (a) in an inert gas atmosphere at 500° C. to 900° C., and thereby obtaining a composite (a) in which lithium phosphorus complex oxide particles represented by the following formula (1):

LiMPO₄ (1)

(wherein M represents one or more metal elements selected from the group consisting of Fe, Mn, Co, Ni and V) are coated with a conductive carbon material; and a granulation step (a) of mechanochemically treating the composite (a) until an average particle size of the aggregate of 1 to 30 μm and a tap density of 0.8 g/cm³ or more are obtained, and thereby obtaining an aggregate (a) in which the lithium phosphorus complex oxide particles represented by the formula (1) are aggregated, with the conductive carbon material binding the particles.

The raw material mixing step (a) related to the method (1) for producing a lithium phosphorus complex oxide-carbon composite of the invention, is a step of obtaining a raw material mixture (a) containing a lithium source, a phosphorus source, M metal element sources, and a conductive carbon material source.

The lithium source related to the raw material mixing step (a) is not particularly limited as long as the lithium source is a compound having elemental lithium, which may produce the lithium phosphorus complex oxide represented by the formula (1) by reacting with other raw materials. Examples of the lithium source include inorganic lithium salts such as lithium hydroxide and lithium carbonate; and organic lithium salts such as lithium oxalate and lithium acetate. The phosphorus source related to the raw material mixing step (a) is not particularly limited as long as the phosphorus source is a compound having elemental phosphorus, which may produce the lithium phosphorus complex oxide represented by the formula (1) by reacting with other raw materials. Examples of the phosphorus source include phosphoric acid esters such as ammonium phosphate, ammonium hydrogen phosphate, ammonium dihydrogen phosphate, triethyl phosphate, and 2-ethylhexyldiphenol phosphate. The one or more metal element sources (M metal element sources) selected from the group consisting of Fe, Mn, Co, Ni and V, as related to the raw material mixing step (a) are not particularly limited as long as the metal element sources are compounds having M metal elements, which may produce the lithium phosphorus complex oxide represented by the formula (1) by reacting with other raw materials. Examples of the metal element sources include oxalates, acetates, oxides, hydroxides, carbonates, sulfates, and nitrates having the M metal elements. For example, when the M metal element is Fe, examples of the M metal element sources include iron oxalate, iron acetate, iron oxide, iron hydroxide, iron carbonate, iron sulfate, and iron nitrate. Furthermore, in the method for producing a lithium phosphorus complex oxide-carbon composite of the invention, a combination of a compound which combines a lithium source and a phosphorus source and a compound which combines a phosphorus source and M metal element sources is preferable from the viewpoint that the reaction operation is facilitated, and the processes can be simplified. An example of such a compound which combines a lithium source and a phosphorus source may be lithium phosphate. An example of such a compound which combines a phosphorus source and M metal element sources may be the phosphate having an M metal element.

The average particle size of the lithium source, phosphorus source and M metal element sources related to the raw material mixing step (a) is preferably 100 μm or less, and particularly preferably 0.1 to 100 μm, from the viewpoint of obtaining a uniform mixture. Furthermore, in order to obtain a high purity lithium phosphorus complex oxide-carbon composite, it is preferable that the lithium source, the phosphorus source and the M metal element sources related to the raw material mixing step (a) have high purity as far as possible.

The conductive carbon material source related to the raw material mixing step (a) is a conductive carbon material, or a precursor of a conductive carbon material. The conductive carbon material related to the conductive carbon material source for the raw material mixing step (a) is the same conductive carbon material as that related to the lithium phosphorus complex oxide-carbon composite of the invention. Furthermore, the precursor of a conductive carbon material related to the conductive carbon material source for the raw material mixing step (a) is the same precursor of a conductive carbon material as that related to the lithium phosphorus complex oxide-carbon composite of the invention.

The conductive carbon material source related to the raw material mixing step (a) may be one kind or two or more kinds of conductive carbon materials, one kind or two or more kinds of precursors of conductive carbon materials, or a combination of one kind or two or more kinds of conductive carbon materials and one kind or two or more kinds of precursors of conductive carbon materials. The conductive carbon material source is preferably a combination of one kind or two or more kinds of conductive carbon materials and one kind or two or more kinds of precursors of conductive carbon materials, and particularly preferably a combination of ketjen black and saccharides, from the viewpoint of improving the rate performance.

The average particle size of the conductive carbon material related to the conductive carbon material source for the raw material mixing step (a) is preferably 1.0 to 50.0 μm, and particularly preferably 1.0 to 10.0 μm. When the average particle size of the conductive carbon material is in the range described above, the electrode density obtainable in the case of using the lithium phosphorus complex oxide-carbon composite as a positive electrode active material, is increased.

The BET specific surface area of the conductive carbon material related to the conductive carbon material source for the raw material mixing step (a) is preferably 100 m²/g or more, and particularly preferably 100 to 1500 m²/g, from the viewpoint of obtaining a uniform mixture.

In regard to the mixing ratio of the lithium source and the phosphorus source for the raw material mixing step (a), the molar ratio of Li atoms/P atoms is preferably 0.8 to 1.2, and particularly preferably 0.9 to 1.1, from the viewpoint of increasing the discharge capacity. In regard to the mixing ratio of the phosphorus source and the M metal element sources for the raw material mixing step (a), the molar ratio of Li atoms/P atoms is preferably 0.8 to 1.2, and particularly preferably 0.9 to 1.1, from the viewpoint of increasing the discharge capacity.

In regard to the raw material mixing step (a), the mixing amount of the conductive carbon material source is preferably an amount such that the content of carbon atoms in the aggregate (a) obtainable by carrying out the granulation step (a) reaches 0.5% to 10% by mass, and particularly preferably 1% to 10% by mass, from the viewpoint of preventing oxidation of the positive electrode active material and increasing the capacity of lithium secondary batteries. In addition, during the calcination process in the calcination step (a), since some of the carbon of the conductive carbon material source volatilizes, the mixing amount of the conductive carbon material source for the raw material mixing step (a) is regulated while considering the calcination temperature or the like, so that the content of carbon atoms in the aggregate (a) obtainable by carrying out the granulation step (a) is in the range described above.

The method of obtaining the raw material mixture (a) in the raw material mixing step (a) is not particularly limited, and examples of the method include a dry mixing method of mixing the lithium source, the phosphorus source, the M metal element sources, and the conductive carbon material source without using a solvent; and a wet mixing method of using a solvent, and mixing the lithium source, the phosphorus source, the M metal element sources and the conductive carbon material source by dissolving or dispersing the sources in the solvent. When the conductive carbon material source is a conductive carbon material, it may be difficult to uniformly disperse the conductive carbon material in a solvent. Therefore, in this case, dry mixing is preferable. Furthermore, in the raw material mixing step (a), the lithium source, the phosphorus source and the M metal element sources may be mixed first, and then the conductive carbon material source may be mixed with these. Alternatively, the lithium source, the phosphorus source, the M metal element sources and the conductive carbon material source may be mixed altogether.

An example of the method for performing dry mixing in the raw material mixing step (a) may be a method of mixing the lithium source, the phosphorus source, the M metal element sources and the conductive carbon material source, by means of a mechanical means in which strong shear force and frictional force are exerted as particle-like media move in a flow at a high speed. Examples of mixing apparatuses that are used for dry mixing include a vibratory ball mill, a vibratory mill, a planetary mill, and a medium agitating mill. In these mixing apparatuses, when pulverizing media such as balls and beads are placed in a mixing vessel in the mixing apparatus, and the raw material mixture (a) is mixed therein together with those pulverizing media, the raw material mixture (a) is mixed while pulverized by the shear force and frictional force of the particle-like media.

The particle size of the particle-like media related to the mixing apparatus for performing dry mixing is preferably 0.1 to 25 mm. Furthermore, the material of the particle-like media related to the mixing apparatus for performing dry mixing is preferably ceramic beads made of zirconia, alumina or the like, from the viewpoint that the material has high hardness and is highly resistant to abrasion, and that metal contamination of the material is prevented.

The filling amount (filling volume) of the particle-like media in the mixing vessel in the mixing apparatus for performing dry mixing is appropriately 50% to 90% of the volume of the mixing vessel.

Examples of the method for performing wet mixing in the raw material mixing step (a) include a method of adding the lithium source, the phosphorus source and the M metal element sources to a solution obtained by dissolving a precursor of a conductive carbon material in a solvent, and mixing these components; and a method of dispersing the lithium source, the phosphorus source and the M metal element sources in a solvent, subsequently adding a precursor of a conductive carbon material, and mixing these components. The solvent related to wet mixing may vary depending on the type of the precursor of a conductive carbon material, but examples include water, tetrahydrofuran, ketones such as acetone; alcohols such as methanol and ethanol; amides such as dimethylformamide, and dimethylacetamide; and hydrocarbons such as toluene, xylene and benzene. These may be used individually, or in combination of two or more kinds. The solids concentration of the lithium source, phosphorus source and M metal element sources in the slurry that is obtained by mixing the lithium source, the phosphorus source and the M metal element sources in a solution prepared by dissolving a precursor of a conductive carbon material in a solvent, is preferably 10% to 50% by mass, and particularly preferably 10% to 40% by mass. Examples of the mixing apparatus used for wet mixing include the mixing apparatuses used for dry mixing.

The particle size of the pulverizing media related to the mixing apparatus for performing wet mixing is preferably 1 to 25 mm. Furthermore, the material of the pulverizing media related to the mixing apparatus for performing wet mixing is preferably ceramic beads made of zirconia, alumina or the like, from the viewpoint that the pulverizing medium has high hardness and is highly resistant to abrasion, and that metal contamination of the material is prevented.

In the case of performing mixing by wet mixing in the raw material mixing step (a), after performing mixing, the solvent is removed from the slurry by heating the resulting slurry to 50° C. to 150° C., preferably by heating the slurry at 50° C. to 150° C. under reduced pressure, or spray drying the slurry, and thus the raw material mixture (a) is obtained.

The pressure molding step (a) related to the method (1) for producing a lithium phosphorus complex oxide-carbon composite of the invention is a step of pressure molding the raw material mixture (a) to obtain a pressure molded product of the raw material mixture (a).

In the pressure molding step (a), the pressurizing force applied at the time of pressure molding the raw material mixture (a) may vary with the type of the pressing machine and the amount of the raw material mixture (a). However, the pressurizing force is usually 5 to 200 MPa, and preferably 20 to 200 MPa. Examples of the pressing machine used in pressure molding include a hand pressing machine, a tabletting machine, a briquetting machine, and a roller compactor.

When the raw material mixture (a) is molded under pressure in the pressure molding step (a), the reactivity of the raw materials can be increased in the subsequent calcination step (a).

The calcination step (a) related to the method (1) for producing the lithium phosphorus complex oxide-carbon composite of the invention is a step of calcining the pressure molded product of the raw material mixture (a) in an inert gas atmosphere such as nitrogen or argon, at 500° C. to 900° C., and preferably at 550° C. to 700° C., and there by obtaining a composite (a) in which the lithium phosphorus complex oxide particles represented by the formula (1) are coated with a conductive carbon material.

In the calcination step (a), when the calcination temperature at which the pressure molded product of the raw material mixture (a) is calcined is in the range described above, it is possible to make the lithium phosphorus complex oxide particles represented by the formula (1) in the aggregate (a) fine. Preferably, the average particle size of the lithium phosphorus complex oxide particles represented by the formula (1) can be adjusted to 10 to 500 nm, and particularly preferably, the average particle size of the lithium phosphorus complex oxide particles represented by the formula (1) can be adjusted to 10 to 300 nm. On the other hand, when the calcination temperature at which the pressure molded product of the raw material mixture (a) is lower than the range described above, the reaction does not proceed sufficiently, and unreacted reactants remain behind. When the calcination temperature is higher than the range described above, sintering between the lithium phosphorus complex oxide particles occurs, and the particle size of the lithium phosphorus complex oxide particles becomes too large. In the calcination step (a), the calcination time for calcining the pressure molded product of the raw material mixture (a) is preferably 2 to 20 hours, and particularly preferably 5 to 10 hours.

In the calcination step (a), the calcination product obtained after once performing calcination of the pressure molded product of the raw material mixture (a) may be pulverized, and calcination of the pulverization product may be carried out again.

In the calcination step (a), the pressure molded product of the raw material mixture (a) is calcined, and then cooling of the calcination product is carried out. Such cooling is preferably carried out in an inert gas atmosphere such as nitrogen or argon.

The calcination product obtained by carrying out the calcination step (a) is a composite (a) in which lithium phosphorus complex oxide particles represented by the formula (1) are coated with a conductive carbon material, as shown in FIG. 1. In the method (1) for producing a lithium phosphorus complex oxide-carbon composite of the invention, the composite (a) may be pulverized before the granulation step (a) is carried out. It is preferable to pulverize the composite (a) before the granulation step (a) is carried out, from the viewpoint of obtaining an aggregate (a) having a high tap density.

The granulation step (a) related to the method (1) for producing a lithium phosphorus complex oxide-carbon composite of the invention is a step of mechanochemically treating the composite (a) until an average particle size of the aggregate of 1 to 30 μm and a tap density of 0.8 g/cm³ or more are obtained, and thereby obtaining an aggregate (a) in which the lithium phosphorus composite oxide particles represented by the formula (1) are aggregated, with a conductive carbon material.

The mechanochemical treatment related to the granulation step (a) is a treatment of applying mechanical energy such as a compressive force, a shear force, a frictional force and a stretching force, to the composite (a). When mechanical energy is applied to the composite (a), plural composite (a) particles are aggregated while compressed. Therefore, the aggregate (a) in which the lithium phosphorus complex oxide particles represented by the formula (1) are aggregated, with a compact conductive carbon material binding the particles, is obtained.

Examples of the apparatus for carrying out the mechanochemical treatment include compressive force shearing type dry apparatuses which are capable of simultaneously exerting a compressive force and a shear force on an object to be treated, such as “Mechanofusion System (manufactured by Hosokawa Micron, Ltd.)” and “Nobilta (manufactured by Hosokawa Micron, Ltd.)”. Furthermore, other examples of the apparatus for carrying out the mechanochemical treatment include “Hybridization System (manufactured by Nara Machinery Co., Ltd.)”.

The treatment conditions for carrying out the mechanochemical treatment with such a compressive force shearing type dry apparatus may be the following conditions. The circumferential speed of the rotor is 30 to 100 m/s, and preferably 30 to 80 m/s. The treatment temperature is 100° C. or lower, and preferably −10° C. to 80° C. The treatment atmosphere is preferably an inert atmosphere.

In the granulation step (a), the treatment apparatus or the treatment conditions for the mechanochemical treatment are appropriately selected, and the mechanochemical treatment of the composite (a) is carried out by, for example, regulating the type of the apparatus, the circumferential speed of the rotor, the treatment time and the like, until an average particle size of the resulting aggregate (a) of 1 to 30 μm, and a tap density of 0.8 g/cm³ or more are obtained.

The average particle size of the aggregate (a) is 1 to 30 μm, and preferably 1 to 20 μm. When the average particle size of the aggregate (a) is less than the range described above, the rate performance of lithium secondary batteries is deteriorated, and when the average particle size is greater than the range described above, the rate performance is deteriorated.

The tap density of the aggregate (a) is 0.8 g/cm³ or more, preferably 0.8 to 2.0 g/cm³, and particularly preferably 0.9 to 2.0 g/cm³. When the tap density of the aggregate (a) is in the range described above, the electrode density of the positive electrode active material is increased, and the rate performance of lithium secondary batteries is improved.

As such, the aggregate (a) can be obtained by carrying out the granulation step (a). In the method (1) for producing a lithium phosphorus complex oxide-carbon composite of the invention, the aggregate (a) obtained after the granulation step (a) is pulverized and classified.

The method for producing a lithium phosphorus complex oxide-carbon composite of a second embodiment of the invention (hereinafter, also described as the method (2) for producing a lithium phosphorus complex oxide-carbon composite of the invention) is a method for producing a lithium phosphorus complex oxide-carbon composite, the method including a first raw material mixing step (b) of mixing a lithium source, a phosphorus source, one or more metal element (M metal element) sources selected from the group consisting of Fe, Mn, Co, Ni and V, and a precursor of a conductive carbon material to obtain a first raw material mixture (b1); a second raw material mixing step (b) of mixing the first raw material mixture (b1) with a conductive carbon material to obtain a second raw material mixture (b2); a pressure molding step (b) of pressure molding the second raw material mixture (b2) to obtain a pressure molded product of the second raw material mixture (b2); a calcination step (b) of calcining the pressure molded product of the second raw material mixture (b2) in an inert gas atmosphere at 500° C. to 900° C., and thereby obtaining a composite (b) in which lithium phosphorus complex oxide particles represented by the following formula (1):

LiMPO₄ (1)

(wherein M represents one or more metal elements selected from the group consisting of Fe, Mn, Co, Ni and V) are coated with the conductive carbon material; and a granulation step (b) of mechanochemically treating the composite (b) until an average particle size of the aggregate of 1 to 30 μm and a tap density of 0.8 g/cm³ or more are obtained, and thereby obtaining an aggregate (b) in which the lithium phosphorus complex oxide particles represented by the formula (1) are aggregated, with the conductive carbon material binding the particles.

The first raw material mixing step (b) related to the method (2) for producing a lithium phosphorus complex oxide-carbon composite of the invention is a step of mixing a lithium source, a phosphorus source, one or more metal element sources (M metal element sources) selected from the group consisting of Fe, Mn, Co, Ni and V, and a precursor of a conductive carbon material to obtain a first raw material mixture (b1).

The lithium source, the phosphorus source, the M metal element sources and the precursor of a conductive carbon material related to the first raw material mixing step (b) are the same as the lithium source, the phosphorus source, the M metal element sources, and the precursor of a conductive carbon material related to the raw material mixing step (a).

The method of mixing the lithium source, the phosphorus source, the M metal element sources and the precursor of a conductive carbon material in the first raw material mixing step (b) to obtain a first raw material mixture (b1), is the same as the method of mixing the lithium source, the phosphorus source, the M metal element sources and the conductive carbon material source in the raw material mixing step (a) to obtain a raw material mixture (a).

The second raw material mixing step (b) related to the method (2) for producing a lithium phosphorus complex oxide-carbon composite of the invention is a step of mixing the first raw material mixture (b1) with a conductive carbon material to obtain the second raw material mixture (b2).

The conductive carbon material related to the second raw material mixing step (b) is the same as the conductive carbon material related to the raw material mixing step (a).

The method of mixing the first raw material mixture (b1) and the conductive carbon material to obtain a second raw material mixture (b2) in the second raw material mixing step (b) is the same as the method of mixing a lithium source, a phosphorus source, M metal element sources and a conductive carbon material source in the raw material mixing step (a) to obtain a raw material mixture (a), except that the first raw material mixture (b1) is used instead of the lithium source, the phosphorus source and the M metal element sources.

The pressure molding step (b) related to the method (2) for producing a lithium phosphorus complex oxide-carbon composite of the invention is a step of pressure molding the second raw material mixture (b2) to obtain a pressure molded product of the second raw material mixture (b2).

The method of pressure molding the second raw material mixture (b2) to obtain a pressure molded product of the second raw material mixture (b2) in the pressure molding step (b) is the same as the method of pressure molding the raw material mixture (a) to obtain a pressure molded product of the raw material mixture (a) in the pressure molding step (a), except that the object to which pressure is applied is different.

The calcination step (b) related to the method (2) for producing a lithium phosphorus complex oxide-carbon composite of the invention is a step of calcining the pressure molded product of the second raw material mixture (b2) in an inert gas atmosphere such as nitrogen or argon at 500° C. to 900° C., and preferably at 550° C. to 700° C., and thereby obtaining a composite (b) in which the lithium phosphorus complex oxide particles represented by the formula (1) are coated with a conductive carbon material.

The method of calcining the pressure molded product of the second raw material mixture (b2) to obtain the composite (b) in the calcination step (b) is the same as the method of calcining the pressure molded product of the raw material mixture (a) to obtain the composite (a) in the calcination step (a), except that the object to be calcined is different.

The granulation step (b) related to the method (2) for producing a lithium phosphorus complex oxide-carbon composite of the invention is a step of mechanochemically treating the composite (b) until an average particle size of the aggregate of 1 to 30 μm and a tap density of 0.8 g/cm³ or more are obtained, and thereby obtaining an aggregate (b) in which the lithium phosphorus complex oxide particles represented by the formula (1) are aggregated, with the conductive carbon material binding the particles.

The method of mechanochemically treating the composite (b) to obtain the aggregate (b) in the granulation step (b) is the same as the method of mechanochemically treating the composite (a) to obtain the aggregate (a) in the granulation step (a), except that the object to be mechanochemically treated is different.

In regard to the method (2) for producing a lithium phosphorus complex oxide-carbon composite of the invention, the mass ratio of the mixing amount (x1) of the precursor of a conductive carbon material to be mixed in the first raw material mixing step (b) and the mixing amount (x2) of the conductive carbon material to be mixed in the second raw material mixing step (b), is preferably such that x1:x2=1:0.1 to 10, and particularly preferably x1:x2=1:0.2 to 5. When the mass ratio of the mixing amount (x1) of the precursor of a conductive carbon material to be mixed in the first raw material mixing step (b) and the mixing amount (x2) of the conductive carbon material to be mixed in the second raw material mixing step (b) is in the range described above, the rate performance of lithium secondary batteries is improved.

As such, the aggregate (b) can be obtained by carrying out the granulation step (b). In the method (2) for producing a lithium phosphorus complex oxide-carbon composite of the invention, after the granulation step (b) is carried out, the aggregate (b) thus obtained is pulverized and classified.

The method for producing a lithium phosphorus complex oxide-carbon composite of a third embodiment of the invention (hereinafter, also described as a method (3) for producing a lithium phosphorus complex oxide-carbon composite of the invention) is a method for producing a lithium phosphorus complex oxide-carbon composite, the method including a raw material mixing step (c) of mixing a lithium source, a phosphorus source, one or more metal element (M metal element) sources selected from the group consisting of Fe, Mn, Co, Ni and V, and a precursor of a conductive carbon material to obtain a raw material mixture (c); a pressure molding step (c) of pressure molding the raw material mixture (c) to obtain a pressure molded product of the raw material mixture (c); a calcination step of calcining the pressure molded product of the raw material mixture (c) in an inert gas atmosphere at 500° C. to 900° C., and thereby obtaining a composite (c) in which lithium phosphorus complex oxide particles represented by the following formula (1):

LiMPO₄ (1)

(wherein M represents one or more metal elements selected from the group consisting of Fe, Mn, Co, Ni and V) are coated with a conductive carbon material; and a granulation step (c) of further mixing the composite (c) with the conductive carbon material, subsequently mechanochemically treating the mixture of the composite (c) and the conductive carbon material until an average particle size of the aggregate of 1 to 30 μm and a tap density of 0.8 g/cm³ or more are obtained, and thereby obtaining an aggregate (c) in which lithium phosphorus complex oxide particles represented by the formula (1) are aggregated, with the conductive carbon material binding the particles.

The raw material mixing step (c) related to the method (3) for producing a lithium phosphorus complex oxide-carbon composite of the invention is a step of mixing a lithium source, a phosphorus source, one or more metal element (M metal element) sources selected from the group consisting of Fe, Mn, Co, Ni and V, and a precursor of a conductive carbon material to obtain a raw material mixture (c).

The lithium source, the phosphorus source, the M metal element sources and the precursor of a conductive carbon material related to the raw material mixing step (c) is the same as the lithium source, the phosphorus source, the M metal element sources and the precursor of a conductive carbon material related to the raw material mixing step (a).

The method of mixing the lithium source, the phosphorus source, the M metal element sources and the precursor of a conductive carbon material to obtain a raw material mixture (c) in the raw material mixing step (c) is the same as the method of mixing the lithium source, the phosphorus source, the M metal element sources and the conductive carbon material source to obtain the raw material mixture (a) in the raw material mixing step (a).

The pressure molding step (c) related to the method (3) for producing a lithium phosphorus complex oxide-carbon composite of the invention is a step of pressure molding the raw material mixture (c) to obtain a pressure molded product of the raw material mixture (c).

The method of pressure molding the raw material mixture (c) to obtain a pressure molded product of the raw material mixture (c) in the pressure molding step (c) is the same as the method of pressure molding the raw material mixture (a) to obtain a pressure molded product of the raw material mixture (a) in the pressure molding step (a).

The calcination step (c) related to the method (3) for producing a lithium phosphorus complex oxide-carbon composite of the invention is a step of calcining the pressure molded product of the raw material mixture (c) in an inert gas atmosphere such as nitrogen or argon at 500° C. to 900° C., and preferably 550° C. to 700° C., and thereby obtaining a composite (c) in which lithium phosphorus complex oxide particles represented by the formula (1) are coated with a conductive carbon material.

The method of calcining the pressure molded product of the raw material mixture (c) to obtain a composite (c) in the calcination step (c) is the same as the method of calcining the pressure molded product of the raw material mixture (a) to obtain the composite (a) in the calcination step (a).

The granulation step (c) related to the method (3) for producing a lithium phosphorus complex oxide-carbon composite of the invention is a step of further adding a conductive carbon material to the composite (c), subsequently mechanochemically treating a mixture of the composite (c) and the conductive carbon material until an average particle size of the aggregate of 1 to 30 μm and a tap density of 0.8 g/cm³ or more are obtained, and thereby obtaining an aggregate (c) in which lithium phosphorus complex oxide particles represented by the formula (1) are aggregated, with the conductive carbon material binding the particles.

In the granulation step (c), first, a conductive carbon material is added to the composite (c). The conductive carbon material related to the granulation step (c) is the same as the conductive carbon material related to the raw material mixing step (a). The method of adding the conductive carbon material to the composite (c) is usually carried out by adding the composite (c) and the conductive carbon material to an apparatus for carrying out the mechanochemical treatment. However, the two components may be mixed in advance before being added to the apparatus for carrying out the mechanochemical treatment.

In the granulation step (c), subsequently, the mixture of the composite (c) and the conductive carbon particles are subjected to a mechanochemical treatment.

The method of mechanochemically treating the mixture of the composite (c) and the conductive carbon particles to obtain an aggregate (c) in the granulation step (c) is the same as the method of mechanochemically treating the composite (a) to obtain the aggregate (a) in the granulation step (a), except that the object to be mechanochemically treated is different.

In the method (3) for producing a lithium phosphorus complex oxide-carbon composite of the invention, the mass ratio of the mixing amount (x1) of the precursor of a conductive carbon material to be mixed in the raw material mixing step (c) and the mixing amount (x2) of the conductive carbon material to be mixed in the granulation step (c) is preferably such that x1:x2=1:0.1 to 10, and particularly preferably x1:x2=1:0.2 to 5. When the mass ratio of the mixing amount (x1) of the precursor of a conductive carbon material to be mixed in the raw material mixing step (c) and the mixing amount (x2) of the conductive carbon material to be mixed in the granulation step (c) is in the range described above, the rate performance of lithium secondary batteries is improved.

As such, the aggregate (c) can be obtained by carrying out the granulation step (c). In the method (3) for producing a lithium phosphorus complex oxide-carbon composite of the invention, after the granulation step (c) is carried out, the aggregate (c) thus obtained is pulverized and classified.

Furthermore, in the method for producing a lithium phosphorus complex-carbon composite of the invention, the raw material mixing step can be carried out by appropriately selecting the treatment apparatus, the treatment conditions and the like so as to perform mixing of the objects to be mixed. Furthermore, in the method for producing a lithium phosphorus complex oxide-carbon composite of the invention, the granulation step can be carried out by appropriately selecting the treatment apparatus, the treatment conditions and the like so that granulation is achieved by subjecting the object of the mechanochemical treatment to the mechanochemical treatment, and thus an aggregate is formed.

The lithium phosphorus complex oxide-carbon composite of the invention is a product in which fine lithium phosphorus complex oxide particles and a conductive carbon material are compressed and aggregated. Thus, plural fine lithium phosphorus complex oxide particles present inside the aggregate are aggregated, with a compact conductive carbon material binding the particles.

As a result, the conductive carbon material in the lithium phosphorus complex oxide-carbon composite of the invention has a higher density as compared with the conductive carbon material of conventional lithium phosphorus complex oxide-carbon composites. Therefore, the lithium phosphorus complex oxide-carbon composite of the invention has a higher tap density, and therefore a higher electrode density, as compared with conventional lithium phosphorus complex oxide-carbon composites.

Furthermore, since the conductive carbon material in the lithium phosphorus complex oxide-carbon composite of the invention is compact as compared with the conductive carbon material of conventional lithium phosphorus complex oxide-carbon composites, the conductive carbon material of the invention has a higher conductivity. Therefore, the lithium phosphorus complex oxide-carbon composite of the invention has enhanced rate performance of lithium secondary batteries as compared with conventional lithium phosphorus complex oxide-carbon composites.

Furthermore, since the lithium phosphorus complex oxide particles in the lithium phosphorus complex oxide-carbon composite of the invention are covered with a compact conductive carbon material, the lithium phosphorus complex oxide-carbon composite of the invention has enhanced rate performance for lithium secondary batteries as compared with conventional lithium phosphorus complex oxide-carbon composites.

The positive electrode active material for lithium secondary batteries of the invention is a positive electrode active material characterized by containing the lithium phosphorus complex oxide-carbon composite of the invention. The lithium secondary battery of the invention is a lithium secondary battery using the lithium phosphorus complex oxide-carbon composite of the invention as the positive electrode active material for lithium secondary batteries, and is composed of a positive electrode, a negative electrode, a separator, and a non-aqueous electrolyte containing a lithium salt.

In the case of using the lithium phosphorus complex oxide-carbon composite of the invention as the positive electrode active material for lithium secondary batteries, the content of the lithium phosphorus complex oxide-carbon composite of the invention in the entire positive electrode active material for lithium secondary batteries is preferably such that the positive electrode active material contains, in terms of the particle number, one or more composite particles, and particularly preferably three or more composite particles, in a field of vision having a size of 30 μm×30 μm under an observation by scanning electron microscopic observation (SEM) at a magnification of 3000 times.

The positive electrode related to the lithium secondary battery of the invention is formed by, for example, applying a positive electrode mixture on a positive electrode collector and drying the system. The positive electrode mixture is formed from a positive electrode active material, an electrically conductive agent, a binder, and an optionally added filler or the like. The lithium secondary battery of the invention is such that the positive electrode active material for lithium secondary batteries of the invention is uniformly applied on a positive electrode. Therefore, the lithium secondary battery of the invention has high battery performance, and particularly high loading characteristics and cycle characteristics.

The content of the positive electrode active material contained in the positive electrode mixture related to the lithium secondary battery of the invention is 70% to 100% by weight, and preferably 90 to 98% by weight.

The positive electrode collector related to the lithium secondary battery of the invention is not particularly limited as long as it is an electron conductor which does not cause chemical changes in a constructed battery, but examples thereof include stainless steel, nickel, aluminum, titanium, baked carbon, and an aluminum or stainless steel surface treated with carbon, nickel, titanium or silver on the surface. These materials may be used after oxidizing the surfaces, or may be used after providing the collector surface with surface irregularity by a surface treatment. Examples of the form of the collector include a foil, a film, a sheet, a net, a punched object, a lath, a porous body, a foam, a group of fibers, and a formed body of a non-woven fabric. The thickness of the collector is not particularly limited, but it is preferable to adjust the thickness to 1 to 500 μm.

The electrically conductive agent related to the lithium secondary battery of the invention is not particularly limited as long as it is an electron conducting material that does not cause chemical changes in a constructed battery. Examples thereof include graphite such as natural graphite and artificial graphite; carbon blacks such as carbon black, acetylene black, ketjen black, channel black, furnace black, lamp black, and thermal black; conductive fibers such as carbon fibers and metal fibers; powdered metals such as carbon fluoride, aluminum, and nickel; conductive whiskers of zinc oxide and potassium titanate; conductive metal oxides such as titanium oxide; and conductive materials such as polyphenylene derivatives. Examples of natural graphite include scale-like graphite, flake graphite, and earth-like graphite. These can be used individually or in combination of two or more kinds. The incorporation ratio of the conductive agent is 1% to 50% by weight, and preferably 2% to 30% by weight, of the positive electrode mixture.

Examples of the binder related to the lithium secondary battery of the invention include starch, polyvinylidene fluoride, polyvinyl alcohol, carboxymethyl cellulose, hydroxypropyl cellulose, recycled cellulose, diacetyl cellulose, polyvinyl pyrrolidone, tetrafluoroethylene, polyethylene, polypropylene, an ethylene-propylene-diene terpolymer (EPDM), a sulfonated EPDM, styrene-butadiene rubber, fluororubber, a tetrafluoroethylene-hexafluoroethylene copolymer, a tetrafluoroethylene-hexafluoropropylene copolymer, a tetrafluoroethylene-perfluoroalkyl vinyl ether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride hexafluoropropylene-tetrafluoroethylene copolymer, a vinylidene fluoride-perfluoromethyl vinyl ether-tetrafluoroethylene copolymer, an ethylene-acrylic acid copolymer or a (Na⁺) ion cross-linked product thereof; an ethylene-methacrylic acid copolymer or a (Na⁺) ion cross-linked product thereof; an ethylene-methyl acrylate copolymer or a (Na+) ion cross-linked product thereof; an ethylene-methyl methacrylate copolymer or a (Na⁺) ion cross-linked product thereof; polysaccharides such as polyethylene oxide; thermoplastic resins, and polymers having rubber elasticity. These can be used individually or in combination of two or more kinds. When a compound containing a functional group that is likely to react with lithium, such as a polysaccharide, is used, it is preferable to add, for example, a compound such as an isocyanate group to deactivate the functional group. The incorporation ratio of the binder is 1% to 50% by weight, and preferably 5% to 15% by weight, of the positive electrode mixture.

The filler related to the lithium secondary battery of the invention is a material capable of suppressing volumetric expansion of the positive electrode or the like in the positive electrode mixture, and is added as necessary. Any fibrous material which does not cause chemical changes in a constructed battery can be used as the filler, but for example, olefin-based polymers such as polypropylene and polyethylene, and fibers of glass, carbon and the like are used. The amount of the filler added is not particularly limited, but the amount is preferably 0% to 30% by weight of the positive electrode mixture.

The negative electrode related to the lithium secondary battery of the invention is formed by applying a negative material on a negative electrode collector and drying the system. The negative electrode collector related to the lithium secondary battery of the invention is not particularly limited as long as it is an electron conductor which does not cause chemical changes in a constructed battery, but examples thereof include stainless steel, nickel, copper, titanium, aluminum, baked carbon, copper or stainless steel surface-treated with carbon, nickel, titanium or silver on the surface, and an aluminum-cadmium alloy. These materials may be used after oxidizing the surfaces, or may be used after providing surface irregularity on the collector surface by a surface treatment. Examples of the form of the collector include a foil, a film, a sheet, a net, a punched object, a lath, a porous body, a foam, a group of fibers, and a formed body of a non-woven fabric. The thickness of the collector is not particularly limited, but it is preferable to adjust the thickness to 1 to 500 μm.

The negative electrode material related to the lithium secondary battery of the invention is not particularly limited, but examples thereof include a carbonaceous material, a metal complex oxide, lithium metal, a lithium alloy, a silicon alloy, a tin alloy, a metal oxide, a conductive polymer, a chalcogen compound, a Li—Co—Ni-based material, and lithium titanate. Examples of the carbonaceous material include a scarcely graphitized carbon material, and a graphite-based carbon material. Examples of the metal complex oxide include compounds such as Snₚ (M¹)₁₋ₚ(M²)_{q}Oᵣ(wherein M¹ represents one or more elements selected from Mn, Fe, Pb and Ge; M² represents one or more elements selected from Al, B, P, Si, elements of Group 1, Group 2 and Group 3 of the Periodic Table, and halogen elements; and 0<p≦1, 1≦q≦3, and 1≦r≦8), LiₜFe₂O₃ (0≦t≦1), and LiₜWO₂ (0≦t≦1). Examples of the metal oxide include GeO, GeO₂, SnO, SnO₂, PbO, PbO₂, Pb₂O₃, Pb₃O₄, Sb₂O₃, Sb₂O₄, Sb₂O₅, Bi₂O₃, Bi₂O₄, and Bi₂O₅. Examples of the conductive polymer include polyacetylene, and poly-p-phenylene.

As the separator related to the lithium secondary battery of the invention, an insulating thin film having a large ion permeability and a predetermined mechanical strength is used. From the viewpoints of resistance to organic solvents and hydrophobicity, a sheet or a non-woven fabric made of an olefinic polymer such as polypropylene, glass fiber, or polyethylene is used. Generally, the pore diameter of the separator may be of any value that is in the range useful for batteries, and is, for example, 0.01 to 10 μm. The thickness of the separator may be of any value in the range for general batteries, and is, for example, 5 to 300 μm. When a solid electrolyte such as a polymer is used as the electrolyte that will be described later, the solid electrolyte may be configured to also serve as a separator.

The non-aqueous electrolyte containing a lithium salt related to the lithium secondary battery of the invention is a product composed of a non-aqueous electrolyte and a lithium salt. Examples of the non-aqueous electrolyte related to the lithium secondary battery of the invention that can be used include a non-aqueous electrolyte solution, an organic solid electrolyte, and an inorganic solid electrolyte. Examples of the non-aqueous electrolyte solution include solvent mixtures prepared by mixing one kind or two or more kinds of aprotic organic solvents such as N-methyl-2-pyrrolidinone, propylene carbonate, ethylene carbonate, butylene carbonate, dimethyl carbonate, diethyl carbonate, γ-butyrolactone, 1,2-dimethoxyethane, tetrahydroxyfuran, 2-methyltetrahydrofuran, dimethyl sulfoxide, 1,3-dioxolane, formamide, dimethylforamide, dioxolane, acetonitrile, nitromethane, methyl formate, methyl acetate, phosphoric acid triesters, trimethoxymethane, dioxolane derivatives, sulfolane, methylsulfolane, 3-methyl-2-oxazolidinone, 1,3-dimethyl-2-imidazolidinone, propylene carbonate derivatives, tetrahydrofuran derivatives, diethyl ether, 1,3-propanesulfone, methyl propionate, and ethyl propionate.

Examples of the solid electrolyte related to the lithium secondary battery of the invention include polyethylene derivatives, polyethylene oxide derivatives or polymers including these, polypropylene oxide derivatives or polymers including these, phosphoric acid ester polymers, polyphosphazene, polymers containing ionic dissociating groups, such as polyaziridine, polyethylene sulfide, polyvinyl alcohol, polyvinylidene fluoride, and polyhexafluoropropylene; and mixtures of polymers containing ionic dissociating groups and the non-aqueous electrolyte solutions described above.

As the inorganic solid electrolyte related to the lithium secondary battery of the invention, the nitride, halide, oxoate, sulfide and the like of Li can be used, and examples include Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, P₂S₅, Li₂S or Li₂S—P₂S₅, Li₂S—SiS₂, Li₂S—GeS₂, Li₂S—Ga₂S₃, Li₂S—B₂S₃, Li₂S—P₂S₅—X, Li₂S—SiS₂—X, Li₂S—GeS₂—X, Li₂S—Ga₂S₃—X, and Li₂S—B₂S₃—X (wherein X represents at least one or more selected from LiI, B₂S₃ and Al₂S₃).

Furthermore, when the inorganic solid electrolyte is amorphous (glassy), compounds containing oxygen, such as lithium phosphate (Li₃PO₄), lithium oxide (Li₂O), lithium sulfate (Li₂SO₄), phosphorus oxide (P₂O₅) and lithium borate (Li₃BO₃); and compounds containing nitrogen, such as Li₃PO₄₋ᵤN_{2u/3} (wherein u is such that 0<u<4), Li₄SiO₄₋ᵤN_{2u/3} (wherein u is such that 0<u<4), Li₄GeO₄₋ᵤN_{2u/3} (wherein u is such that 0<u<4), and Li₃BO₃₋ᵤN_{2u/3} (wherein u is such that 0<u<3) can be incorporated into the inorganic solid electrolyte. As a result of the addition of these compounds containing oxygen or compounds containing nitrogen, the gaps in the amorphous skeleton thus formed are widened, any hindrance to the migration of lithium ions is reduced, and thereby ion conductivity can be further enhanced.

As the lithium salt related to the lithium secondary battery of the invention, those lithium salts that dissolve in the non-aqueous electrolyte are used, and examples include salts selected from any one kind or mixtures of two or more kinds of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiB₁₀Cl₁₀, LiAlCl₄, CH₃SO₃Li, CF₃SO₃Li, (CF₃SO₂)₂NLi, chloroborane lithium, lithium lower aliphatic carboxylates, lithium tetraphenylborate, and imides.

Furthermore, the following compounds can be added to the non-aqueous electrolyte for the purpose of improving discharge and charge characteristics and flame retardancy. Examples of the compounds include pyridine, triethyl phosphite, triethanolamine, cyclic ethers, ethylenediamine, n-glyme, hexaphosphoric acid triamide, nitrobenzene derivatives, sulfur, quinoneimine dyes, N-substituted oxazolidinone and N,N-substituted imidazolidine, ethylene glycol dialkyl ether, ammonium salts, polyethylene glycol, pyrrole, 2-methoxyethanol, aluminum trichloride, monomers of conductive polymer electrode active materials, triethylene phosphonamide, trialkylphosphine, morpholine, aryl compounds containing carbonyl groups, hexamethylphosphoric triamide and 4-alkylmorpholine, bicyclic tertiary amines, oils, phosphonium salts and tertiary sulfonium salts, phosphazene, and carbonic acid esters. Furthermore, in order to render the electrolyte solution incombustible, a halogen-containing solvent, for example, tetrachlorocarbon or trifluoroethylene can be incorporated into the electrolyte solution. Also, in order to impart adaptability to high temperature storage, carbon dioxide can be incorporated into the electrolyte solution.

The lithium secondary battery of the invention is a lithium secondary battery having excellent rate performance, and the shape of the battery may be any of a button shape, a cylinder shape, a polygon shape and a coin shape.

There are no particular limitations on the use of the lithium secondary batteries of the invention, but examples include notebook computers, laptop computers, electronic appliances such as pocket word processors, mobile telephones, cordless handsets, portable CD players, radios, liquid crystal TV sets, back-up power supplies, electric shavers, memory cards, and video cameras; and electronic appliances for consumer use, such as automobiles, electric vehicles, electronic game machines, and electric tools.

### EXAMPLES

Hereinafter, the invention will be described in detail based on Examples, but the invention is not intended to be limited to these Examples.

### Example 1

<Raw Material Mixing Step>

10 kg of ferrous phosphate hydrate (Fe₃(PO₄)₂.8H₂O, average particle size 10.1 μm) and 2.4 kg of lithium phosphate (Li₃PO₄, average particle size 5.5 μm) were dispersed in water, and thus a slurry having a solids concentration of 40% by mass was prepared. Subsequently, the slurry was placed in a wet bead mill apparatus and was subjected to a wet mixing treatment. Subsequently, the slurry was dried by evaporating water in the slurry, and thus a mixture was obtained. The treatment conditions for the wet bead mill apparatus were as follows.
Fluidized media: zirconia beads (average particle size 0.5 mm)
Fill volume: 85 vol %
Circumferential speed: 10.0 m/s

1 kg of ketjen black (average particle size 0.05 μm, BET specific surface area 754 m²/g, manufactured by Ketjen Black International Company, trade name: ECP) was added to the mixture obtained, and the resulting mixture was sufficiently mixed with a Henschel mixer. Thus, a raw material mixture was obtained.

<Pressure Molding Step>

10 g of the raw material mixture thus obtained was press molded at 44 MPa with a hand pressing machine, and thus a pressure molded product was obtained.

<Calcination Step>

The pressure molded product thus obtained was calcined in a nitrogen atmosphere at 600° C. for 5 hours, and after calcination, the pressure molded product was cooled in a nitrogen atmosphere. Subsequently, the calcination product thus obtained was pulverized, and then was classified. Thus, a composite (A1) was obtained. The composite (A1) thus obtained was subjected to an XRD analysis, and it was confirmed that single phase LiFePO₄ had been produced.

<Granulation Step>

The composite (A1) was introduced into a Nobilta (type: NOB-130) manufactured by Hosokawa Micron, Ltd., and was subjected to a mechanochemical treatment. Thus, an aggregate (A2) was obtained. The conditions for the mechanochemical treatment were as follows.
Speed of rotation of rotor: 4000 rpm
Gap between rotor and vessel internal wall: 3.0 mm
Treatment time: 5 minutes

### Example 2

<Raw Material Mixing Step>

10 kg of ferrous phosphate hydrate (Fe₃(PO₄)₂.8H₂O, average particle size 10.1 μm) and 2.4 kg of lithium phosphate (Li₃PO₄, average particle size 5.5 μm) were dispersed in water, and thus a slurry having a solids concentration of 40% by mass was prepared. Subsequently, the slurry was placed in a wet bead mill apparatus and was subjected to a wet mixing treatment under the same conditions as those used in Example 1. Subsequently, the slurry was dried by evaporating water in the slurry, and thus a mixture was obtained.

Subsequently, 1.3 kg of sucrose was added to the mixture thus obtained, and the resulting mixture was sufficiently mixed with a Henschel mixer. Thus, a raw material mixture was obtained.

<Pressure Molding Step>

10 g of the raw material mixture thus obtained was press molded at 44 MPa with a hand pressing machine, and thus a pressure molded product was obtained.

<Calcination Step>

The pressure molded product thus obtained was calcined in a nitrogen atmosphere at 600° C. for 5 hours, and after calcination, the pressure molded product was cooled in a nitrogen atmosphere. Subsequently, the calcination product thus obtained was pulverized, and then was classified. Thus, a composite (B1) was obtained. The composite (B1) thus obtained was subjected to an XRD analysis, and it was confirmed that single phase LiFePO₄ had been produced.

<Granulation Step>

The composite (B1) was introduced into a Nobilta (type: NOB-130) manufactured by Hosokawa Micron, Ltd., and was subjected to a mechanochemical treatment. Thus, an aggregate (B2) was obtained. The conditions for the mechanochemical treatment were the same as those used in Example 1.

### Example 3

<Raw Material Mixing Step>

10 kg of ferrous phosphate hydrate (Fe₃(PO₄)₂.8H₂O, average particle size 10.1 μm) and 2.4 kg of lithium phosphate (Li₃PO₄, average particle size 5.5 μm) were dispersed in water, and thus a slurry having a solids concentration of 40% by mass was prepared. Subsequently, the slurry was placed in a wet bead mill apparatus and was subjected to a wet mixing treatment under the same conditions as those used in Example 1. Subsequently, the slurry was dried by evaporating water in the slurry, and thus a mixture was obtained.

Subsequently, 1.17 kg of starch and 650 g of ketjen black used in Example 1 were added to the mixture thus obtained, and the resulting mixture was sufficiently mixed with a Henschel mixer. Thus, a raw material mixture was obtained.

<Pressure Molding Step>

10 g of the raw material mixture thus obtained was press molded at 44 MPa with a hand pressing machine, and thus a pressure molded product was obtained.

<Calcination Step>

The pressure molded product thus obtained was calcined in a nitrogen atmosphere at 700° C. for 5 hours, and after calcination, the pressure molded product was cooled in a nitrogen atmosphere. Subsequently, the calcination product thus obtained was pulverized, and then was classified. Thus, a composite (C1) was obtained. The composite (C1) thus obtained was subjected to an XRD analysis, and it was confirmed that single phase LiFePO₄ had been produced.

<Granulation Step>

The composite (C1) was introduced into a Nobilta (type: NOB-130) manufactured by Hosokawa Micron, Ltd., and was subjected to a mechanochemical treatment. Thus, an aggregate (C2) was obtained. The conditions for the mechanochemical treatment were the same as those used in Example 1.

### Example 4

<Raw Material Mixing Step>

10 kg of ferrous phosphate hydrate (Fe₃(PO₄)₂.8H₂O, average particle size 10.1 μm) and 2.4 kg of lithium phosphate (Li₃PO₄, average particle size 5.5 μm) were dispersed in water, and thus a slurry having a solids concentration of 40% by mass was prepared. Subsequently, 1.3 kg of sucrose was added to the slurry. Subsequently, the resulting slurry was placed in a wet bead mill apparatus and was subjected to a wet mixing treatment under the same conditions as those used in Example 1. Subsequently, the slurry was dried by evaporating water in the slurry, and thus a first raw material mixture was obtained.

Subsequently, 650 g of ketjen black used in Example 1 was added to the first raw material mixture thus obtained, and the resulting mixture was sufficiently mixed with a Henschel mixer. Thus, a second raw material mixture was obtained.

<Pressure Molding Step>

10 g of the second raw material mixture thus obtained was press molded at 44 MPa with a hand pressing machine, and thus a pressure molded product was obtained.

<Calcination Step>

The pressure molded product thus obtained was calcined in a nitrogen atmosphere at 650° C. for 5 hours, and after calcination, the pressure molded product was cooled in a nitrogen atmosphere. Subsequently, the calcination product thus obtained was pulverized, and then was classified. Thus, a composite (D1) was obtained. The composite (D1) thus obtained was subjected to an XRD analysis, and it was confirmed that single phase LiFePO₄ had been produced.

<Granulation Step>

The composite (D1) was introduced into a Nobilta (type: NOB-130) manufactured by Hosokawa Micron, Ltd., and was subjected to a mechanochemical treatment. Thus, an aggregate (D2) was obtained. The conditions for the mechanochemical treatment were the same as those used in Example 1.

### Comparative Example 1

<Raw Material Mixing>

10 kg of ferrous phosphate hydrate (Fe₃(PO₄)₂.8H₂O, average particle size 10.1 μm) and 2.4 kg of lithium phosphate (Li₃PO₄, average particle size 5.5 μm) were dispersed in water, and thus a slurry having a solids concentration of 40% by mass was prepared. Subsequently, the slurry was placed in a wet bead mill apparatus and was subjected to a wet mixing treatment. Subsequently, the slurry was dried by evaporating water in the slurry, and thus a mixture was obtained. The treatment conditions in the wet bead mill apparatus were as follows.
Fluidized media: zirconia beads (average particle size 0.5 mm)
Fill volume: 85 vol %
Circumferential speed: 10.0 m/s

Subsequently, 1 kg of ketjen black used in Example 1 was added to the mixture thus obtained, and the resulting mixture was sufficiently mixed with a Henschel mixer. Thus, a raw material mixture was obtained.

<Pressure Molding>

10 g of the raw material mixture thus obtained was press molded at 44 MPa with a hand pressing machine, and thus a pressure molded product was obtained.

<Calcination>

The pressure molded product thus obtained was calcined in a nitrogen atmosphere at 600° C. for 5 hours, and after calcination, the pressure molded product was cooled in a nitrogen atmosphere. Subsequently, the calcination product thus obtained was pulverized, and then was classified. Thus, a composite (a1) was obtained. The composite (a1) thus obtained was subjected to an XRD analysis, and it was confirmed that single phase LiFePO₄ had been produced.

### Comparative Example 2

<Raw Material Mixing>

10 kg of ferrous phosphate hydrate (Fe₃(PO₄)₂.8H₂O, average particle size 10.1 μm) and 2.4 kg of lithium phosphate (Li₃PO₄, average particle size 5.5 μm) were dispersed in water, and thus a slurry having a solids concentration of 40% by mass was prepared. Subsequently, the slurry was placed in a wet bead mill apparatus and was subjected to a wet mixing treatment under the same conditions as those used in Example 1. Subsequently, the slurry was dried by evaporating water in the slurry, and thus a mixture was obtained.

Subsequently, 1.3 kg of sucrose was added to the mixture thus obtained, and the resulting mixture was sufficiently mixed with a Henschel mixer. Thus, a raw material mixture was obtained.

<Pressure Molding>

10 g of the raw material mixture thus obtained was press molded at 44 MPa with a hand pressing machine, and thus a pressure molded product was obtained.

<Calcination>

The pressure molded product thus obtained was calcined in a nitrogen atmosphere at 600° C. for 5 hours, and after calcination, the pressure molded product was cooled in a nitrogen atmosphere. Subsequently, the calcination product thus obtained was pulverized, and then was classified. Thus, a composite (b1) was obtained. The composite (b1) thus obtained was subjected to an XRD analysis, and it was confirmed that single phase LiFePO₄ had been produced.

### Comparative Example 3

<Raw Material Mixing>

10 kg of ferrous phosphate hydrate (Fe₃(PO₄)₂.8H₂O, average particle size 10.1 μm) and 2.4 kg of lithium phosphate (Li₃PO₄, average particle size 5.5 μm) were dispersed in water, and thus a slurry having a solids concentration of 40% by mass was prepared. Subsequently, the slurry was placed in a wet bead mill apparatus and was subjected to a wet mixing treatment. Subsequently, the slurry was dried by evaporating water in the slurry, and thus a mixture was obtained. The treatment conditions for the wet bead mill apparatus were the same as those used in Example 1.

Subsequently, 1 kg of ketjen black used in Example 1 was added to the mixture thus obtained, and the resulting mixture was sufficiently mixed with a Henschel mixer. Thus, a raw material mixture was obtained.

<Pressure Molding>

10 g of the raw material mixture thus obtained was press molded at 44 MPa with a hand pressing machine, and thus a pressure molded product was obtained.

<Calcination>

The pressure molded product thus obtained was calcined in a nitrogen atmosphere at 600° C. for 5 hours, and after calcination, the pressure molded product was cooled in a nitrogen atmosphere. Subsequently, the calcination product thus obtained was pulverized, and then was classified. Thus, a composite (c1) was obtained. The composite (c1) thus obtained was subjected to an XRD analysis, and it was confirmed that single phase LiFePO₄ had been produced.

<Mixing>

The composite (c1) was subjected to a mixing treatment with a Henschel mixer, and thus an agitation-treated product (c2) of the composite was obtained.

TABLE 1

| | | Molar ratio of raw | | | Calcination |
|---|---|---|---|---|---|
| | | materials fed | | | temperature |
| | | Li | Fe | P | (° C.) |
| Example 1 | Ketjen black | 1.060 | 1.000 | 1.020 | 600 |
| Example 2 | Sucrose | 1.060 | 1.000 | 1.020 | 600 |
| Example 3 | Starch | 1.060 | 1.000 | 1.020 | 700 |
| | Ketjen black | | | | |
| Example 4 | Ketjen black | 1.060 | 1.000 | 1.020 | 650 |
| Comparative | Ketjen black | 1.060 | 1.000 | 1.020 | 600 |
| Example 1 | | | | | |
| Comparative | Sucrose | 1.060 | 1.000 | 1.020 | 600 |
| Example 2 | | | | | |
| Comparative | Ketjen black | 1.060 | 1.000 | 1.020 | 600 |
| Example 3 | | | | | |

(Properties Evaluation)

(1) For the composites (A1) to (D1) obtained in Examples 1 to 4, and the composites (a1) to (c1) obtained in Comparative Examples 1 to 3, the average particle size of the lithium phosphorus complex oxide particles in the composites, the BET specific surface areas, the tap densities and the carbon atom contents of the composites (A1) to (D1) and the composites (a1) to (c1) were determined.

<Measurement of Average Particle Size of Lithium Phosphorus Complex Oxide Particles in Composite>

The measurement was made by scanning electron microscopy (SEM).

<Carbon Atom Content>

The carbon atom content was determined by making a measurement with a TOC total organic carbon meter (TOC-5000A manufactured by Shimadzu Corp.).

<Tap Density>

A mass cylinder is completely dried, and the weight of the empty mass cylinder is measured. About 40 g of a sample is taken on a powder paper. The sample is transferred into a 50-ml mass cylinder using a funnel. The mass cylinder is mounted on an automatic T.D. analyzer (Dual Autotap manufactured by Yuasa Electronics Corp.), and tapping is carried out while the number of taps is set to 500. The graduation of the sample meniscus is read, and thus the weight of the mass cylinder is measured. Thus, the tap density is calculated (tapping height 3.2 mm, tapping pace 200 times/min).

TABLE 2

| | | | BET | | |
|---|---|---|---|---|---|
| | | Average | specific | | |
| | | particle | surface | Tap | C atom |
| | | size | area | density | content |
| | Sample | (nm)¹⁾ | (m²/g) | (g/cm³) | (mass %) |
| Example 1 | Composite | 120 | 55.0 | 0.62 | 7.0 |
| | A1 | | | | |
| Example 2 | Composite | 200 | 27.0 | 0.70 | 2.5 |
| | B1 | | | | |
| Example 3 | Composite | 70 | 55.0 | 0.65 | 2.2 |
| | C1 | | | | |
| Example 4 | Composite | 80 | 62.7 | 0.72 | 7.0 |
| | D1 | | | | |
| Comparative | Composite | 300 | 55.0 | 0.62 | 5.0 |
| Example 1 | a1 | | | | |
| Comparative | Composite | 210 | 27.0 | 0.70 | 2.7 |
| Example 2 | b1 | | | | |
| Comparative | Composite | 60 | 55.0 | 0.65 | 6.2 |
| Example 3 | c1 | | | | |

¹⁾Average particle size of the lithium phosphorus complex oxide particles in the composite

(2) For the aggregates (A2) to (D2) obtained in Examples 1 to 4, the composites (a1) to (b1) obtained in Comparative Examples 1 to 2, and the agitation-treated product (c2) obtained in Comparative Example 3, the average particle size, the BET specific surface area, the tap density and the carbon atom content were determined. The average particle size is a value measured with a laser particle size distribution analyzer.

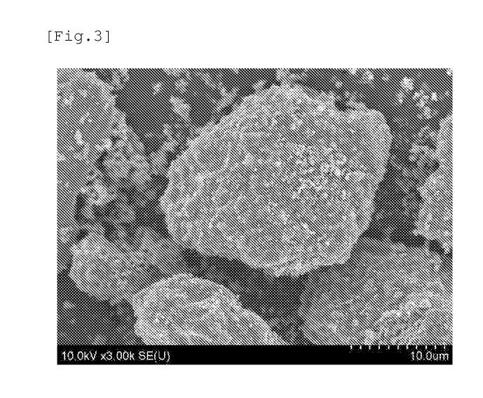

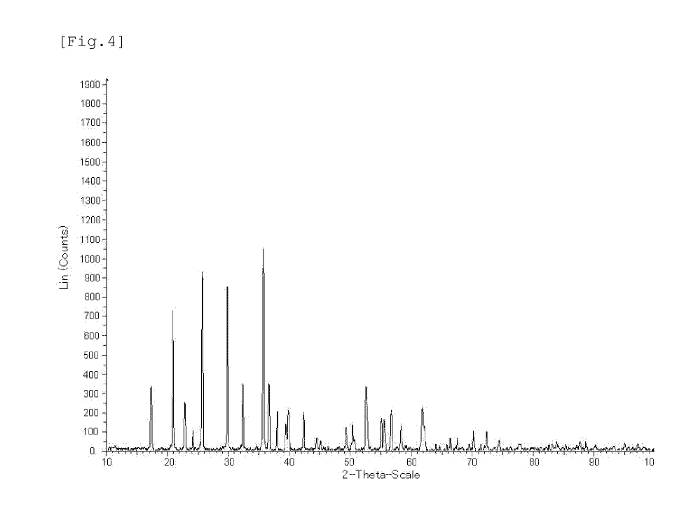

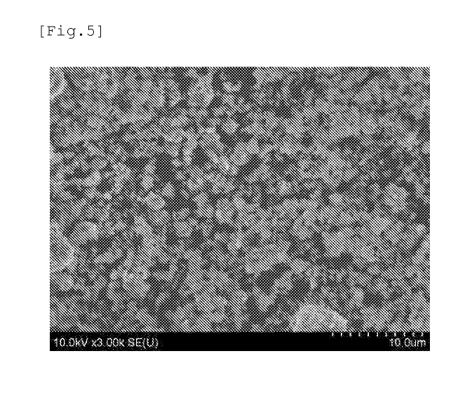

FIG. 3 shows an electron microscopic photograph of the aggregate A2 obtained in Example 1, and FIG. 4 shows an X-ray diffraction chart of the aggregate. Furthermore, FIG. 5 shows an electron microscopic photograph of the agitation-treated product (c2) obtained in Comparative Example 3.

TABLE 3

| | | | BET | | |
|---|---|---|---|---|---|
| | | Average | specific | | |
| | | particle | surface | Tap | C atom |
| | | size | area | density | content |
| | Sample | (μm)¹⁾ | (m²/g) | (g/cm³) | (mass %) |
| Example 1 | Aggregate | 11.2 | 60.2 | 0.85 | 7.0 |
| | A2 | | | | |
| Example 2 | Aggregate | 12.0 | 30.1 | 0.99 | 2.5 |
| | B2 | | | | |
| Example 3 | Aggregate | 18.2 | 28.9 | 0.90 | 2.2 |
| | C2 | | | | |
| Example 4 | Aggregate | 15.0 | 52.1 | 1.10 | 7.0 |
| | D2 | | | | |
| Comparative | Composite | — | — | — | — |
| Example 1 | a1 | | | | |
| Comparative | Composite | — | — | — | — |
| Example 2 | b1 | | | | |
| Comparative | Agitation- | 0.8 | 52.0 | 0.65 | 6.2 |
| Example 3 | treated | | | | |
| | product c2 | | | | |

¹⁾Average particle size of the aggregate for Examples 1 to 4, and the average particle size of the lithium phosphorus complex oxide particles in the composite for Comparative Example 3

<Battery Performance Test>

(I) Production of lithium ion secondary battery:

77% by weight of each of the aggregates (A2), (B2), (C2), (D2) obtained in Examples 1 to 4, the composites (a1) and (b1) obtained in Comparative Examples 1 and 2, and the agitation-treated product (c2) obtained in Comparative Example 3, 8% by weight of ketjen black powder, and 15% by weight of polyvinylidene fluoride were mixed to obtain a positive electrode mixture. This was dispersed in N-methyl-2-pyrrolidinone to prepare a kneaded paste. The kneaded paste was applied on an aluminum foil, and then was dried. The dried paste was punched to a disc having a diameter of 15 mm by pressing, and thus a positive electrode plate was obtained.

This positive electrode plate was used, and various members such as a separator, a negative electrode, a positive electrode, a collector plate, a mounting bracket, an external terminal, and an electrolyte solution were used to produce a lithium secondary battery. Among these, a metal lithium foil was used as the negative electrode, and a solution obtained by dissolving 1 mole of LiPF₆ in 1 liter of a 1:1 mixed liquid of ethylene carbonate and diethyl carbonate, was used as the electrolyte solution.

(II) Evaluation of Battery Performance

The lithium secondary batteries thus produced were operated at room temperature. The rate discharge capacities were measured, and thus the battery performance was evaluated.

(III) Method for Evaluating Rate Discharge Capacity

The positive electrode was charged to 4.2 V under CCCV conditions (0.5 C), and then was discharged to 2.0 V (0.1 C). This process was repeated for 10 cycles. Subsequently, the positive electrode was charged to 4.2 V under CCCV conditions (0.5 C) and discharged to 2.0 V (2.0 C). The discharge capacity at that time was designated as the rate discharge capacity. The results are shown in Table 4.

(IV) Method for Evaluating Electrode Density

The thickness and the weight of the positive electrode plate obtained by punching into a disc having a diameter of 15 mm in the section (I) were measured, and the electrode density was calculated.

TABLE 4

| | | Rate discharge | Electrode |
|---|---|---|---|
| | | capacity | density |
| | Sample | (2.0 C, mAh/g) | (g/cm³) |
| Example 1 | Aggregate A2 | 142 | 2.91 |
| Example 2 | Aggregate B2 | 144 | 2.90 |
| Example 3 | Aggregate C2 | 148 | 2.99 |
| Example 4 | Aggregate D2 | 152 | 3.08 |
| Comparative | Composite a1 | 131 | 2.69 |
| Example 1 | | | |
| Comparative | Composite b1 | 132 | 2.72 |
| Example 2 | | | |
| Comparative | Agitation-treated | 128 | 2.60 |
| Example 3 | product c2 | | |

### DESCRIPTION OF REFERENCE NUMERALS

1 Lithium phosphorus complex oxide particles
2 Conductive carbon material
3 Composite
5 Conductive carbon material
10 Aggregate

It should be understood by those skilled in the art that various modifications, combinations, sub-combinations and alterations may occur depending on design requirements and other factors insofar as they are within the scope of the appended claims or the equivalents thereof.

1. A lithium phosphorus complex oxide-carbon composite comprising an aggregate in which lithium phosphorus complex oxide particles represented by the following formula (1):
LiMPO₄ (1)
(wherein M represents one or more metal elements selected from the group consisting of Fe, Mn, Co, Ni and V) are aggregated, with a conductive carbon material,
wherein the average particle size of the aggregate is 1 to 30 μm, and the tap density of the aggregate is 0.8 g/cm³ or more.

2. The lithium phosphorus complex oxide-carbon composite according to claim 1, wherein the content of the conductive carbon material in the aggregate is 0.5% to 10% by mass in terms of carbon atoms.

3. The lithium phosphorus complex oxide-carbon composite according to claim 1, wherein the average particle size of the lithium phosphorus complex oxide particles represented by the formula (1) in the aggregate is 10 to 500 nm.

4. The lithium phosphorus complex oxide-carbon composite according to claim 1, wherein the electrode density is 2.8 g/cm³ or more.

5. The lithium phosphorus complex oxide-carbon composite according to claim 1, wherein the BET specific surface area is 10 m²/g or more.

6. A method for producing a lithium phosphorus complex oxide-carbon composite, the method comprising:
a raw material mixing step (a) of mixing a lithium source, a phosphorus source, one or more metal element (M metal element) sources selected from the group consisting of Fe, Mn, Co, Ni and V, and a conductive carbon material source to obtain a raw material mixture (a);
a pressure molding step (a) of pressure molding the raw material mixture (a) to obtain a pressure molded product of the raw material mixture (a);
a calcination step (a) of calcining the pressure molded product of the raw material mixture (a) in an inert gas atmosphere at 500° C. to 900° C., and thereby obtaining a composite (a) in which lithium phosphorus complex oxide particles represented by the following formula (1):
LiMPO₄ (1)
(wherein M represents one or more metal elements selected from the group consisting of Fe, Mn, Co, Ni and V) are coated with a conductive carbon material; and
a granulation step (a) of mechanochemically treating the composite (a) until an average particle size of the aggregate of 1 to 30 μm and a tap density of 0.8 g/cm³ or more are obtained, and thereby obtaining an aggregate (a) in which the lithium phosphorus complex oxide particles represented by the formula (1) are aggregated, with the conductive carbon material binding the particles.

7. A method for producing a lithium phosphorus complex oxide-carbon composite, the method comprising:
a first raw material mixing step (b) of mixing a lithium source, a phosphorus source, one or more metal element (M metal element) sources selected from the group consisting of Fe, Mn, Co, Ni and V, and a precursor of a conductive carbon material to obtain a first raw material mixture (b1);
a second raw material mixing step (b) of mixing a conductive carbon material with the first raw material mixture (b1) to obtain a second raw material mixture (b2);
a pressure molding step (b) of pressure molding the second raw material mixture (b2) to obtain a pressure molded product of the second raw material mixture (b2);
a calcination step (b) of calcining the pressure molded product of the second raw material mixture (b2) in an inert gas atmosphere at 500° C. to 900° C., and thereby obtaining a composite (b) in which lithium phosphorus complex oxide particles represented by the following formula (1):
LiMPO₄ (1)
(wherein M represents one or more metal elements selected from the group consisting of Fe, Mn, Co, Ni and V) are coated with a conductive carbon material; and
a granulation step (b) of mechanochemically treating the composite (b) until an average particle size of the aggregate of 1 to 30 μm and a tap density of 0.8 g/cm³ or more are obtained, and thereby obtaining an aggregate (b) in which the lithium phosphorus complex oxide particles represented by the following formula (1) are aggregated, with the conductive carbon material binding the particles.

8. A method for producing a lithium phosphorus complex oxide-carbon composite, the method comprising:
a raw material mixing step (c) of mixing a lithium source, a phosphorus source, one or more metal element (M metal element) sources selected from the group consisting of Fe, Mn, Co, Ni and V, and a precursor of a conductive carbon material to obtain a raw material mixture (c);
a pressure molding step (c) of pressure molding the raw material mixture (c) to obtain a pressure molded product of the raw material mixture (c);
a calcination step (c) of calcining the pressure molded product of the raw material mixture (c) in an inert gas atmosphere at 500° C. to 900° C., and thereby obtaining a complex (c) in which lithium phosphorus complex oxide particles represented by the following formula (1):
LiMPO₄ (1)
(wherein M represents one or more metal elements selected from the group consisting of Fe, Mn, Co, Ni and V) are coated with a conductive carbon material; and
a granulation step (c) of further mixing a conductive carbon material to the composite (c), subsequently mechanochemically treating the mixture of the composite (c) and the conductive carbon material until an average particle size of the aggregate of 1 to 30 μm and a tap density of 0.8 g/cm³ are obtained, and thereby obtaining an aggregate (c) in which the lithium phosphorus complex oxide particles represented by the formula (1) are aggregated, with the conductive carbon material binding the particles.

9. The method for producing a lithium phosphorus complex oxide-carbon composite according to claim 7, wherein the precursor of a conductive carbon material is a saccharide.

10. The method for producing a lithium phosphorus complex oxide-carbon composite according to claim 6, wherein the mechanochemical treatment of the granulation step is carried out by a mechanical means for exerting a compressive force and a shear force on an object to be treated.

11. A positive electrode active material for lithium secondary batteries, comprising the lithium phosphorus complex oxide-carbon composite according to claim 1.

12. A lithium secondary battery using the lithium phosphorus complex oxide-carbon composite according to claim 1 as a positive electrode active material for lithium secondary batteries.
